(19) United States
(12) Patent Application Publication
(10) Pub. No.: US 2018/0025422 A1
(43) Pub. Date: Jan. 25, 2018

(54) METHOD AND SYSTEM FOR REAL-TIME CONTROLS ON CREDIT CHECK REQUESTS

(71) Applicant: MasterCard International Incorporated, Purchase, NY (US)

(72) Inventors: Amyn Mohamed DHALA, Jersey City, NJ (US); Mark N. SAVOYE, Hartsdale, NY (US); Jill Boyd BUGH, Town and Country, MO (US); Frederick Michael PACHER, Williston Park, NY (US)

(73) Assignee: MasterCard International Incorporated, Purchase, NY (US)

(21) Appl. No.: 15/215,953

(22) Filed: Jul. 21, 2016

(51) Int. Cl. G06Q 40/02; G06Q 20/40

(52) U.S. Cl. CPC G06Q 40/025; G06Q 20/40

(57) ABSTRACT

A method for determining real-time authorization of a credit check includes: storing a plurality of account profiles, each including an account number and communication preferences; receiving a transaction message related to an electronic transaction from a payment network, the message including a specific account number, a credit identifier, and transaction data; identifying a specific account profile that includes the specific account number; transmitting a credit check request to a computing device associated with the specific account profile based on the communication preferences, the credit check request including data stored in the received transaction message; receiving an indication of approval of a credit check associated with the electronic transaction from the computing device; and transmitting a return message to the payment network, wherein the return message includes the indication of approval.

### FIELD

The present disclosure relates to controls on real-time credit check requests, specifically the determination of authorization for a credit check in real-time during authorization of a payment transaction for authorization of a credit check to be performed by or on behalf of the merchant by the consumer involved in the transaction.

### BACKGROUND

Credit checks can many times have a negative effect on a consumer's credit score or in the perception of the consumer's credit based on, for example, the number of hard or soft credit inquiries. In many cases, consumers may not realize how often their credit is being checked, and may even be unaware of the entities that are checking their credit. In some instances, a merchant with whom a consumer is transacting may check the consumer's credit as part of the transaction process, such as by checking the consumer's credit before allowing an installment purchase or before entering into a financing agreement with the consumer. In many such instances, the merchant may initiate the credit check to check the consumer's credit unbeknownst to the consumer.

Many consumers are often interested in being more proactive and involved in their financial life, including monitoring what entities are checking their credit and in what circumstances. However, while credit checks can often be monitored, there is a lack of tools available to consumers to control which entities are allowed to check their credit, and when such checks can be performed. As a result, a consumer may be well-informed as to how often their credit is being checked and by whom, but may have little recourse as to how to control or limit such checks. The existence of tens of millions of consumers makes any approval process daunting, posing significant challenges as to the latency, the necessary scale of computer and network resources that might be needed, and challenges in providing the correct level of privacy and security. This process could not be done in a human mind, with pen and paper, but instead must be tied to a technology.

Thus, there is a need for a technical solution where the ability to perform a credit check can be controlled such that a consumer can provide permission to a merchant for the performing of a credit check prior to the check occurring. In such instances, the consumer may be provided with the control that they desire, which may have a positive effect on their credit report. In addition, the tracking of such permission may ensure that, if credit checks are still performed despite a lack of authorization by the consumer, such an omission can be proven, which can support the consumer in a dispute of the actions performed by an unauthorized merchant.

### SUMMARY

The present disclosure provides a description of systems and methods for determining real-time authorization of a credit check.

A method for determining real-time authorization of a credit check includes: storing, in an account database of a processing server, a plurality of account profiles, wherein each account profile includes a structured data set related to a transaction account including at least an account number and communication preferences; receiving, by a receiving device of the processing server, a transaction message related to an electronic transaction from a payment network, wherein the transaction message is formatted based on one or more standards and includes a plurality of data elements including at least a first data element configured to store a specific account number, a second data element configured to store a credit identifier, and one or more additional data elements configured to store transaction data; executing, by a querying module of the processing server, a query on the account database to identify a specific account profile where the included account number corresponds to the specific account number stored in the first data element included in the received transaction message; electronically transmitting, by a transmitting device of the processing server, a data signal to a computing device associated with the identified specific account profile based on the communication preferences included in the identified specific account profile, wherein the data signal is superimposed with a credit check request including at least one data value included in the transaction data stored in the one or more additional data elements included in the received transaction message; receiving, by the receiving device of the processing server, a response data signal from the computing device, wherein the response data signal is superimposed with an indication of approval of a credit check associated with the electronic transaction; and electronically transmitting, by the transmitting device of the processing server, a return message to the payment network, wherein the return message is formatted based on the one or more standards and includes the plurality of data elements and where the indication of approval is stored in one of: the second data element and a third data element.

A system for determining real-time authorization of a credit check includes: an account database of a processing server configured to store a plurality of account profiles, wherein each account profile includes a structured data set related to a transaction account including at least an account number and communication preferences; a receiving device of the processing server configured to receive a transaction message related to an electronic transaction from a payment network, wherein the transaction message is formatted based on one or more standards and includes a plurality of data elements including at least a first data element configured to store a specific account number, a second data element configured to store a credit identifier, and one or more additional data elements configured to store transaction data; a querying module of the processing server configured to execute a query on the account database to identify a specific account profile where the included account number corresponds to the specific account number stored in the first data element included in the received transaction message; and a transmitting device of the processing server configured to electronically transmit a data signal to a computing device associated with the identified specific account profile based on the communication preferences included in the identified specific account profile, wherein the data signal is superimposed with a credit check request including at least one data value included in the transaction data stored in the one or more additional data elements included in the received transaction message. The receiving device of the processing server is further configured to receive a response data signal from the computing device, wherein the response data signal is superimposed with an indication of approval of a credit check associated with the electronic transaction. The transmitting device of the processing server is further configured to electronically transmit a return message to the payment network, wherein the return message is formatted based on the one or more standards and includes the plurality of data elements and where the indication of approval is stored in one of: the second data element and a third data element.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for real-time authorization of credit checks during an electronic payment transaction in accordance with exemplary embodiments.

FIG. 2 is a block diagram illustrating the processing server of FIG. 1 for the processing of real-time authorization for a credit check during an electronic payment transaction in accordance with exemplary embodiments.

FIGS. 3A and 3B are a flow diagram illustrating a process for real-time authorization of a credit check during an electronic payment transaction using the system of FIG. 1 in accordance with exemplary embodiments.

FIG. 4 is a flow diagram illustrating a process for processing real-time authorization of a credit check during an electronic payment transaction using the processing server of FIG. 2 in accordance with exemplary embodiments.

FIG. 5 is a flow chart illustrating an exemplary method for determining real-time authorization of a credit check in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for tens of thousands and even millions of transactions a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Rails—Infrastructure associated with a payment network used in the processing of payment transactions and the communication of transaction messages and other similar data between the payment network and other entities interconnected with the payment network that handles tens of thousands and even millions of transactions in a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

### System for Real-Time Credit Check Authorization

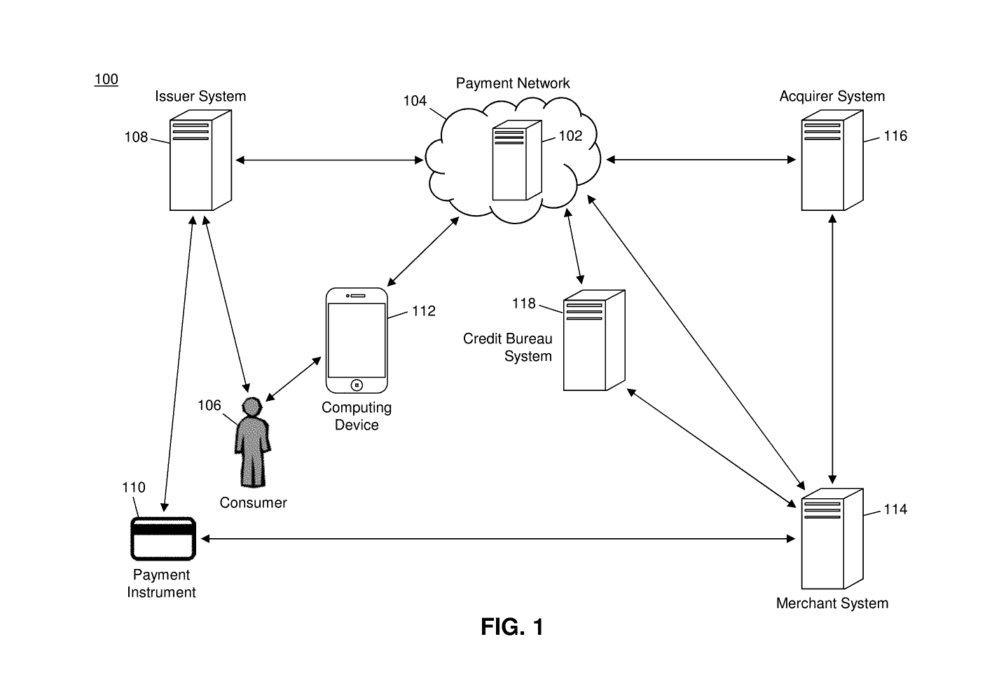

FIG. 1 illustrates a system 100 for the providing of real-time authorization for a credit check during an electronic payment transaction.

The system 100 may include a processing server 102. The processing server 102, discussed in more detail below, may be included in party of a payment network 104 configured to process payment transactions using traditional methods and systems. The processing server 102 may be configured to process real-time authorizations for credit checks are part of the processing of payment transactions by the payment network 104 using the methods and systems discussed herein.

In the system 100, a consumer 106 may have a transaction account associated with an issuer system 108, which may be a computing system associated with an issuing financial institution, such as an issuing bank, configured to issue transaction accounts to consumers for use in funding payment transactions. As part of the issuing of the transaction account to the consumer 106, the issuer system 108 may issue a payment instrument 110 to the consumer 106, such as a check, credit card, debit card, or other type of payment instrument 110 suitable for use in providing payment details as part of a payment transaction. Payment details may include a primary account number, payment cryptogram, transaction counter, and/or any other data suitable for use in identifying and authorization a transaction account for use in funding a payment transaction.

The consumer 106 may also be associated with a computing device 112. The computing device 112 may be any type of computing device suitable for performing the functions discussed herein, such as a desktop computer, laptop computer, notebook computer, tablet computer, cellular phone, smart phone, smart watch, smart television, wearable computing device, implantable computing device, etc. The consumer 106 may use the computing device 112 to register their transaction account with the processing server 102 for use of the service of the processing server 102 for providing real-time authorization of credit checks involving the consumer's transaction account. As part of the registration, the consumer 106 may, via the computing device 112, electronically transmit a data signal to the processing server 102 using a suitable communication network and method that is superimposed or otherwise encoded with an account identifier associated with the transaction account, such as the primary account number, and communication preferences. The communication preferences may include any data suitable for use by the processing server 102 in communicating with the consumer 106 for obtaining authorization for credit checks, such as a communication method and associated details. For example, the communication preferences may indicate short messaging service (SMS) messages as a preferred method of communication, while providing a device identifier associated with the computing device 112 as a destination for the SMS messages. Other methods of communication may include, for example, e-mail, telephone, multimedia message service message, an application program executed by the computing device 112, etc.

Once the consumer 106 has registered with the processing server 102, the consumer 106 may conduct a payment transaction with a merchant via a merchant system 114 associated therewith. As part of the initiation of the payment transaction, the consumer 106 may present the payment instrument 110 to the merchant system 114. The merchant system 114 may read, receive, or otherwise obtain payment details associated with the transaction account associated with the consumer 106 via the payment instrument 110. For example, the payment instrument 110 may include a magnetic strip encoded with the payment details, which may be read by the merchant system 114, the payment instrument 110 may display a machine-readable code encoded with the payment details, which may be read by the merchant system 114, the payment instrument 110 may electronically transmit the payment details to the merchant system 114 via near field communication, etc.

The merchant system 114 may receive the payment details and may submit the payment details, along with additional transaction data, to the payment network 104 for processing. The additional transaction data may include any data suitable for use in processing a payment transaction, such as a transaction amount, transaction time, transaction date, geographic location, point of sale data, consumer data, merchant data, product data, offer data, loyalty data, reward data, acquirer data, issuer data, etc. In some instances, the merchant system 114 may forward the payment details and additional transaction data to an acquirer system 116, which may be a system associated with an acquiring financial institution, such as an acquiring bank, that issues a transaction account to the merchant for receipt of payment in payment transactions, and/or other intermediate entities for forwarding to the payment network 104 for processing, such as a gateway processor.

Prior to submission to the payment network 104, the payment details and additional transaction data may be included in a transaction message suitable for electronic transmission to the payment network 104 via payment rails associated therewith. A transaction message may be a specially formatted data message that is formatted pursuant to one or more standards governing the exchange of financial transaction messages, such as the International Organization of Standardization's ISO 8583 standard. A transaction message may include a message type indicator indicative of a type for the transaction message, such as an authorization request. A transaction message may also include a plurality of data elements, where each data element is configured to store data for the related payment transaction, such as the payment details and additional transaction data. The transaction message may also include one or more bitmaps, which may be configured to indicate the data elements included in the transaction message and the data stored therein.

The merchant system 114 may (e.g., via the acquirer system 116 and/or other intermediate entities) electronically transmit a transaction message to the payment network 104 for the payment transaction via the payment rails associated therewith. The transaction message may include a message type indicator indicative of an authorization request and a plurality of data elements that include a data element configured to store the primary account number associated with the transaction account used by the consumer 106 (e.g., and read from the payment instrument 110) and additional data elements configured to store additional transaction data.

The transaction message may also include a data element configured to store a credit identifier. The credit identifier may be an identifier used to indicate that the merchant system 114 requests authorization from the consumer 106 to perform a credit check on the consumer 106. In some instances, the credit identifier may be a social security number or other identification value provided by the consumer 106 that will be used in performing the credit check. In some cases, the credit identifier may also include data associated with a credit bureau system 118 with whom the credit check is to be performed, such as an identification value associated with the credit bureau system 118, such as the credit bureau's name. In some instances, the credit identifier or other data included in the data element may also indicate a type of the desired credit check, such as a hard or soft credit inquiry.

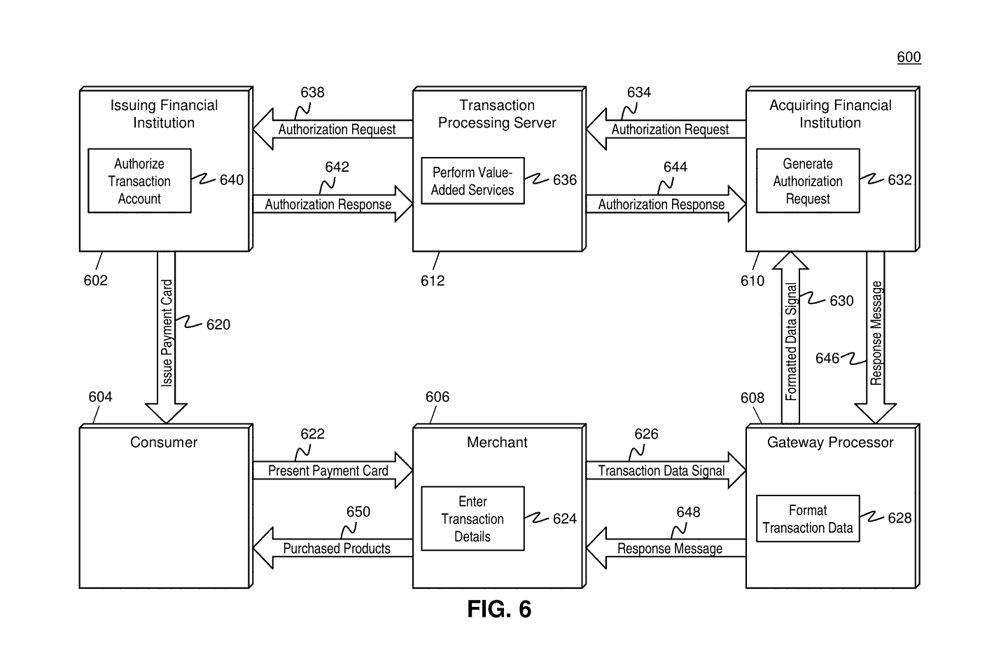

The payment network 104 may receive the authorization request for the transaction message and may process the transaction message using traditional methods and systems. For example, the payment network 104 may perform any services, such as fraud scoring, and may forward the authorization request to the issuer system 108 for approval or denial thereof. Additional detail regarding traditional processing of a payment transaction is discussed in more detail below with respect to the process 600 illustrated in FIG. 6.

As part of the processing, the payment network 104 may forward the transaction message to the processing server 102 using internal processing methods. The processing server 102 may be configured to receive the authorization request and to seek real-time authorization for the credit check from the consumer 106. The processing server 102 may identify that the authorization request includes the credit identifier in the corresponding data element that indicates that a credit check is requested. The processing server 102 may then electronically transmit a data signal to the computing device 112 using the communication preferences provided by the consumer 106 during registration that is superimposed or otherwise encoded with information associated with the credit check request. For example, the information may include a name or other details associated with the merchant system 114, such as may be parsed from data elements included in the authorization request, as well as information indicated in the data element configured to store the credit identifier, such as the credit identifier, data associated with the credit bureau system 118, the type of credit check, etc.

The computing device 112 may receive the data signal, may parse the data superimposed or otherwise encoded thereon, and may display the data to the consumer 106 using a suitable display device. Using a suitable input device, the consumer 106 may input into the computing device 112 and indication of authorization or denial of authorization for the requested credit check. The computing device 112 may electronically transmit a data signal back to the processing server 102 using the communication network and method that is superimposed or otherwise encoded with the consumer's indicated authorization or denial of authorization. For example, if the credit check request information was submitted to the computing device 112 via an SMS message, the consumer 106 may respond in an SMS message that indicates if the credit check request is authorized or not.

The processing server 102 may receive the data signal and may parse the data superimposed or otherwise encoded thereon to obtain the consumer's authorization or denial of authorization. The authorization or denial may then be included in the data element configured to store the credit identifier or a suitable alternative data element to be included in a response transaction message that is electronically transmitted to the merchant system 114 (e.g., through the acquirer system 116 and/or one or more intermediate entities) for the payment transaction. The response transaction message may be a modification of the authorization request or a newly generated transaction message that includes a message type indicator indicative of an authorization response that includes the data elements included in the authorization request as well as a data element configured to store a response code indicating if the payment transaction is approved or denied (e.g., such as indicated by the issuer system 108 during traditional processing of the payment transaction). The processing server 102 or other computing device in the payment network 104 may store the consumer's indicated authorization or denial of authorization in the data element configured to store the credit identifier or other suitable data element included in the authorization response.

The merchant system 114 may receive the authorization response and/or the data included therein, and may finalize the payment transaction accordingly. The merchant system 114 may also proceed with a credit check if the consumer 106 conveyed authorization for the credit check. If the consumer 106 provided a denial of the authorization, the merchant system 114 may be informed thereof and may refrain from performing the credit check. If the merchant system 114 proceeds with the credit check despite the consumer's 106 denying of authorization, the consumer 106 may receive proof of the denial from the processing server 102 and/or payment network 104, which may be used in a dispute to the credit bureau system 118 or other entity associated therewith to show that the consumer 106 did not authorize the credit check performed by the merchant system 114.

In some embodiments, the processing server 102 may be configured to perform the credit check if authorized by the consumer 106. In such an embodiment, the processing server 102 may electronically transmit a data signal to the credit bureau system 118 via a suitable communication network and method that is superimposed or otherwise encoded with a credit check request. The credit check request may include the credit identifier or other data included in the corresponding data element included in the authorization request received for the payment transaction, such as identifying information associated with the consumer 106, credit check type, etc. The credit bureau system 118 may perform a credit check on the consumer 106 and may return results to the processing server 102 using the communication network and method. The processing server 102 may receive the credit check results and may convey them to the merchant system 114. In some instances, the processing server 102 may electronically transmit a data signal directly to the merchant system 114 using a suitable communication network and method, which may include the payment rails associated with the payment network 104, that is superimposed or otherwise encoded with the credit check results. In other instances, the credit check results may be stored in the data element in the authorization response configured to store the credit identifier or another suitable data element included in the authorization response. The merchant system 114 may then receive the results along with the standard approval or denial of the payment transaction by the issuer system 108.

In some embodiments, the payment transaction conducted between the consumer 106 and merchant system 114 may be for a zero or nominal transaction amount, with the payment transaction used for identity authentication purposes (e.g., via the issuer system 108 using traditional methods) and for obtaining authorization of the consumer 106 for performing a credit check. In such an embodiment, the merchant system 114 may utilize the processing server 102 for obtaining the consumer's authorization, such as in place of obtaining the authorization directly from the consumer 106, such that the processing server 102 may be a third party that can verify the consumer's decision in future circumstances.

Methods and systems discussed herein may enable the processing server 102 to provide a consumer 106, and in fact potentially millions of consumers, with the ability to provide authorization for a credit check in real-time when requested by a merchant system 114 as part of a payment transaction. The consumer 106 may thus be able to control merchants that check their credit and may have proof of instances when a merchant is denied authorization to perform a credit check, but proceeds to check the consumer's credit anyway. The use of the payment rails associated with a payment network 104 may also enable the credit check authorization to occur as part of a payment transaction, which may provide for added security to the consumer 106 as well as ensure trusted third party verification of the consumer's provided authorization or lack thereof.

### Processing Server

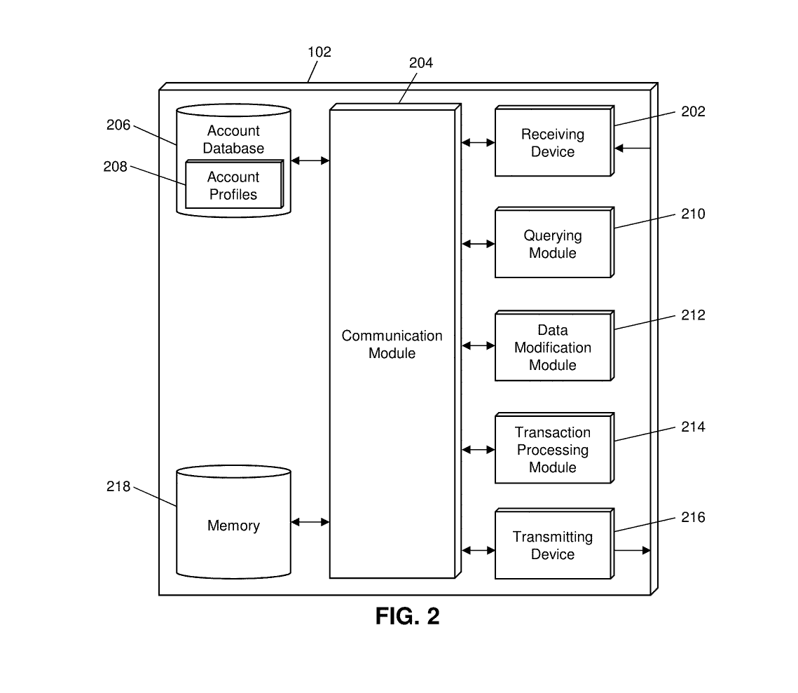

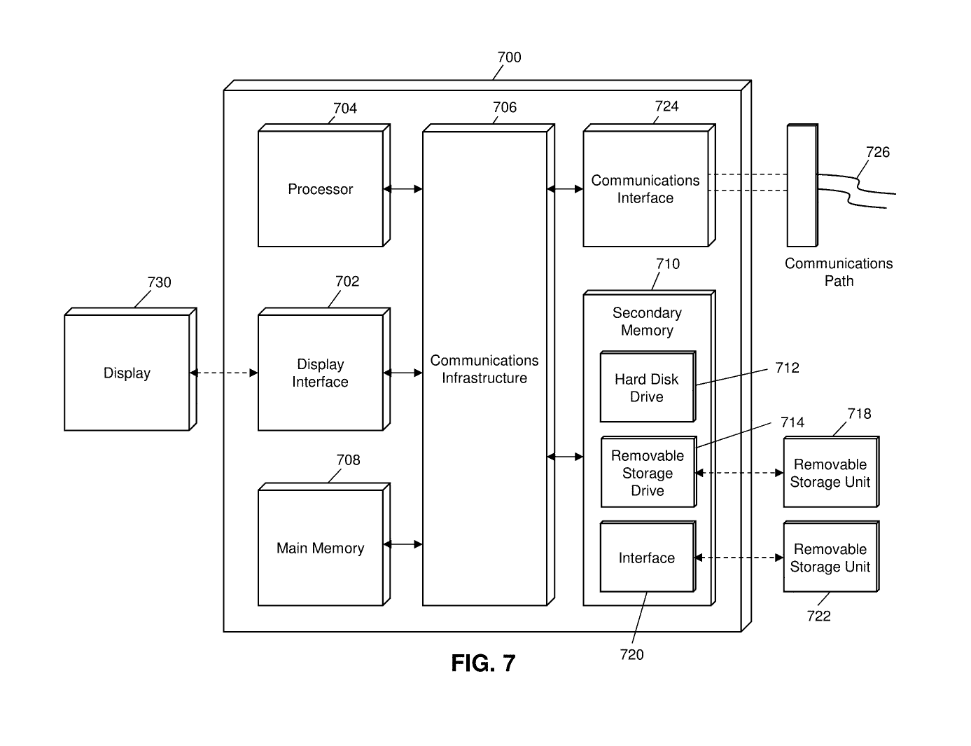

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 104 for the transmission of transaction messages that include sensitive financial data and information. In some instances, the receiving device 202 may also be configured to receive data from payment networks 104, issuer systems 108, computing devices 112, merchant systems 114, acquirer systems 116, credit bureau systems 118, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by payment networks 104, merchant systems 114, acquirer systems 116, and issuer systems 108 that are superimposed or otherwise encoded with transaction messages for payment transactions. Transaction messages may be formatted pursuant to one or more standards, including the ISO 8583 standard, and include a message type indicator and a plurality of data elements, including a data element configured to store an account identifier and a data element configured to store a credit identifier. The receiving device 202 may also be configured to receive data signals electronically transmitted by computing devices 112, which may be superimposed or otherwise encoded with account registration and/or management data, and authorizations or denials of authorization for credit check request. In some embodiments, the receiving device 202 may also be configured to receive data signals electronically transmitted by credit bureau systems 118 using a suitable communication network and method that are superimposed or otherwise encoded with credit check results.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 210, a data modification module 212, a transaction processing module 214, etc. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a transaction account. Each account profile 208 may include at least an account identifier and communication preferences. The account identifier may be a primary account number or other data associated with the related transaction account for identification thereof, as may be included in a transaction message. The communication preferences may include data suitable for use in the transmission of data signals to a computing device 112 associated with the account profile for providing real-time authorization for credit check requests.

The processing server 102 may include a querying module 210. The querying module 210 may be configured to execute queries on databases to identify information. The querying module 210 may receive one or more data values or query strings, and may execute a query string based thereon on an indicated database, such as the account database 206, to identify information stored therein. The querying module 210 may then output the identified information to an appropriate engine or module of the processing server 102 as necessary. The querying module 210 may, for example, execute a query on the account database 206 to identify an account profile 208 related to an authorization request for a payment transaction received from the merchant system 114 or acquirer system 116 via the payment rails, using the account identifier stored in a corresponding data element included therein.

The processing server 102 may also include a data modification module 212. The data modification module 212 may be configured to receive data and instructions related thereto, may modify the data as per the instructions, and may output the modified data to another module or engine of the processing server 102. The data modification module 212 may be configured, for example, to modify the data element included in a transaction message configured to store a credit identifier. For instance, the data modification module 212 may remove the credit identifier included therein when an authorization request is forwarded to an issuer system 108 for approval/denial and may insert the credit identifier and other data (e.g., the consumer's authorization or denial of authorization, credit check results from the credit bureau system 118, etc.) into the corresponding authorization response prior to forwarding to the acquirer system 116 or merchant system 114.

The processing server 102 may also include a transaction processing module 214. The transaction processing module 214 may be configured to perform functions related to the processing of payment transactions, such as fraud scoring, application of transaction controls, reformatting of data included in transaction messages, cryptogram validation, authentication, routing of transaction messages, etc. The transaction processing module 214 may also be configured to generate data requests for use in performing the functions of the processing server 102 as discussed herein, such as data requests for transmission to the computing device 112 associated with a consumer 106 involved in a payment transaction for which a credit check is requested. Such data requests may include data included in one or more data elements in the related authorization request, and may be formatted based on the communication preferences included in a related account profile 208, such as may be identified via the querying module 210.

The processing server 102 may also include a transmitting device 216. The transmitting device 216 may be configured to transmit data over one or more networks via one or more network protocols. In some embodiments, the transmitting device 216 may be configured to transmit data over the payment rails, such as using specially configured infrastructure associated with payment networks 104 for the transmission of transaction messages that include sensitive financial data and information, such as identified payment credentials. In some instances, the transmitting device 216 may be configured to transmit data to payment networks 104, issuer systems 108, computing devices 112, merchant systems 114, acquirer systems 116, credit bureau systems 118, and other entities via alternative networks, such as the Internet. In some embodiments, the transmitting device 216 may be comprised of multiple devices, such as different transmitting devices for transmitting data over different networks, such as a first transmitting device for transmitting data over the payment rails and a second transmitting device for transmitting data over the Internet. The transmitting device 216 may electronically transmit data signals that have data superimposed that may be parsed by a receiving computing device. In some instances, the transmitting device 216 may include one or more modules for superimposing, encoding, or otherwise formatting data into data signals suitable for transmission.

The transmitting device 216 may be configured to electronically transmit data signals to payment networks 104, issuer systems 108, merchant systems 114, and acquirer systems 116, which may be superimposed or otherwise encoded with transaction messages for payment transactions, which may include authorization requests and authorization responses, including authorization responses that may include consumer authorizations or denials of authorization for credit check requests and credit check results. The transmitting device 216 may also be configured to electronically transmit data signals to computing devices 112 using suitable communication networks and methods that may be superimposed or otherwise encoded with data suitable for use in the registration and management of transaction accounts, as well as requests for real-time authorization for credit checks. In some embodiments, the transmitting device 216 may also be configured to electronically transmit data signals to credit bureau systems 118 via suitable communication networks and methods that are superimposed or otherwise encoded with credit check requests, which may include data stored in a data element included in an authorization requests configured to store a credit identifier and other associated data.

The processing server 102 may also include a memory 220. The memory 220 may be configured to store data for use by the processing server 102 in performing the functions discussed herein. The memory 220 may be configured to store data using suitable data formatting methods and schema and may be any suitable type of memory, such as read-only memory, random access memory, etc. The memory 220 may include, for example, currency and geographic location associations, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art.

### Real-Time Authorization of a Credit Check in a Payment Transaction

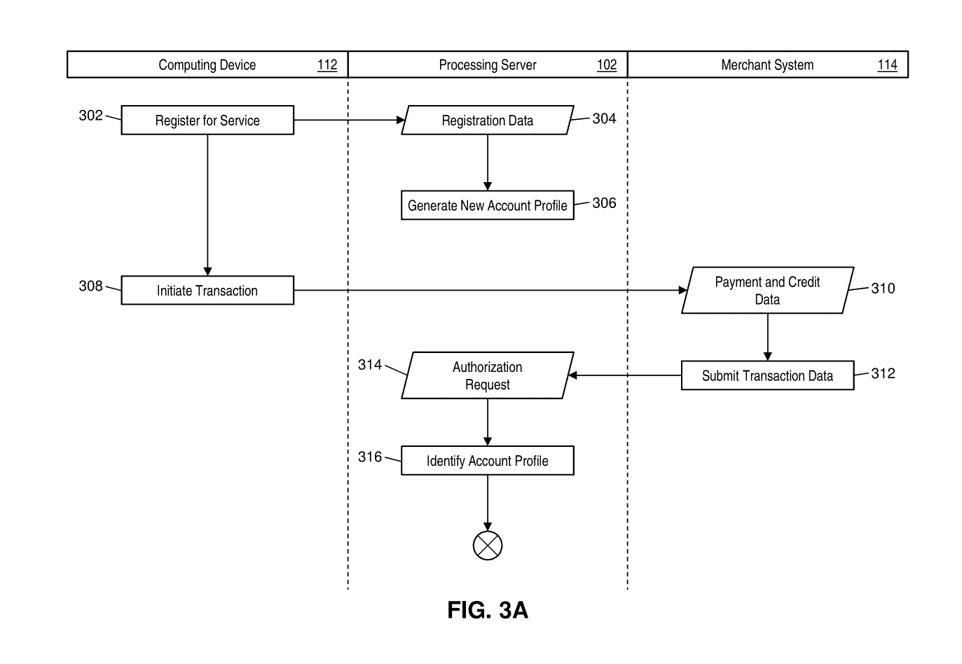

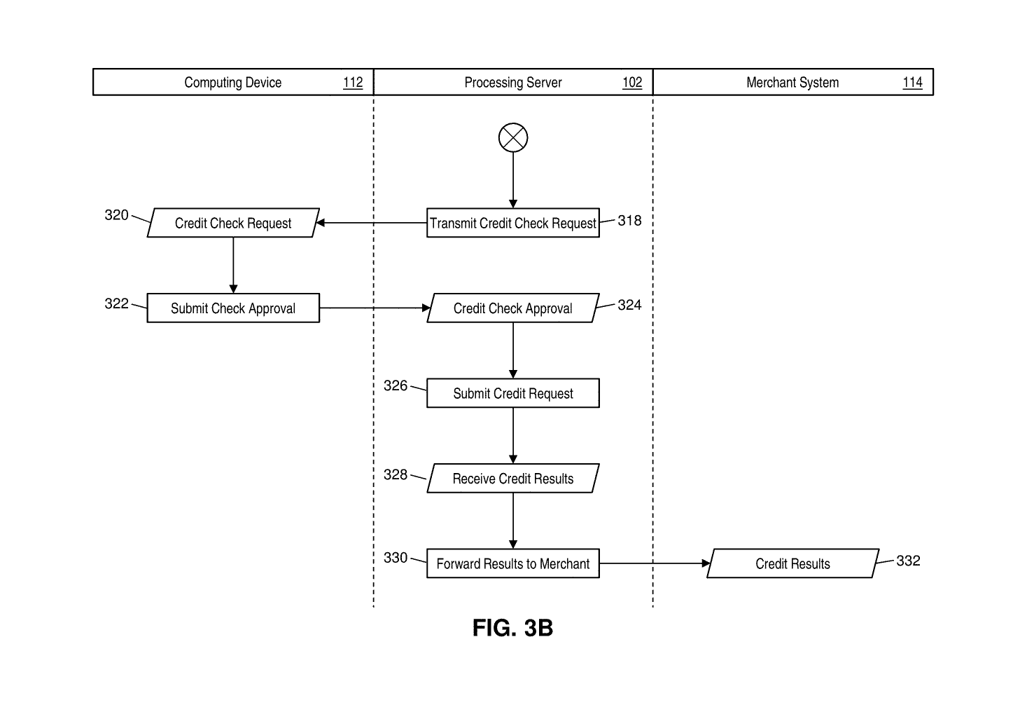

FIGS. 3A and 3B illustrate a process for the real-time authorization of a credit check by a consumer 106 involved in a payment transaction with a merchant system 114 using the processing server 102.

In step 302, the consumer 106 may use the computing device 112 to register for the real-time credit check authorization service provided by the processing server 102. As part of the registration, the computing device 112 may electronically transmit a data signal to the processing server 102 that is superimposed or otherwise encoded with at least an account identifier, such as a primary account number, associated with a transaction account and communication preferences for use in communicating with the computing device 112. The data signal may be electronically transmitted via a suitable network, such as a radio frequency network, cellular communication network, the Internet, etc.

In step 304, the receiving device 202 of the processing server 102 may receive the data signal and parse the data superimposed or otherwise encoded thereon. In step 306, the querying module 210 of the processing server 102 may execute a query on the account database 206 included in the processing server 102 to insert a new account profile 208 in the account database 206 related to the registered transaction account. The new account profile 208 may include at least the account identifier and communication preferences provided by the consumer 106 during the registration process. The account profile 208 may also include any additional registration data, such as preferences of the consumer 106 regarding data to be included in a credit check request.

In step 308, the consumer 106 may initiate a payment transaction with the merchant system 114 using the computing device 112 or via any other suitable method. The payment transaction may be, for example, an in-person transaction conducted by the consumer 106 at a physical location of the merchant system 114, a remote transaction conducted via telephone or the Internet via the computing device 112, etc. In step 310, the merchant system 114 may receive payment and credit data from the consumer 106 as part of the initiation of the payment transaction. The payment data may include at least the account identifier associated with the transaction account being used by the consumer 106 and any additional payment details suitable for processing a payment transaction thereby. The credit data may include identifying information provided by the consumer 106 suitable for performing a credit check thereon, such as a social security number, tax identification number, or other suitable identification value.

In step 312, the merchant system 114 may submit transaction data for a payment transaction to the processing server 102, where the transaction data may include at least the payment data, credit data, and any additional transaction data used in the processing of the payment transaction, such as a transaction amount, transaction time, transaction date, geographic location, consumer data, merchant data, point of sale data, product data, offer data, reward data, loyalty data, acquirer data, issuer data, etc. The transaction data may be included in a plurality of data elements stored in a transaction message formatted pursuant to one or more standards, such as the ISO 8583 standard, which may be generated by the merchant system 114 or by another system associated therewith, such as the acquirer system 116. The transaction message may also include a message type indicator indicative of an authorization request, and may be directly transmitted to the processing server 102 by the merchant system 114 via the payment rails associated with the payment network 104, or transmitted via one or more intermediate entities, such as the acquirer system 116.

In step 314, the receiving device 202 of the processing server 102 may receive the authorization request via the payment rails associated with the payment network 104. In step 316, the querying module 210 of the processing server 102 may execute a query on the account database 206 included therein to identify the account profile 208 related to the transaction account being used in the payment transaction. The account profile 208 may be identified as an account profile 208 that includes the account identifier stored in the corresponding data element included in the authorization request. In step 318, the transaction processing module 214 of the processing server 102 may generate a credit check request that includes data associated with the merchant system 114 and/or the payment transaction as may be parsed from the data elements included in the authorization request, and any credit data, if applicable, such as identification of the credit bureau system 118 and credit check type. In some instances, the data included in the credit check request may be based on consumer preferences, such as may be provided during registration and stored in the identified account profile 208. The credit check request may be superimposed or otherwise encoded on a data signal electronically transmitted by the transmitting device 216 of the processing server 102 to the computing device 112 based on the communication preferences stored in the identified account profile 208.

In step 320, the computing device 112 may receive the credit check request. The computing device 112 may display the credit check request or data included therein to the consumer 106 using a suitable display device. The consumer 106 may indicate their authorization or denial of authorization of the credit check using a suitable input device of the computing device 112. In step 322, the computing device 112 may electronically transmit a data signal back to the processing server 102 that is superimposed or otherwise encoded with the consumer's authorization or denial of authorization. In step 324, the receiving device 202 of the processing server 102 may receive the data signal. In some instances, the data signal may also be superimposed or otherwise encoded with identifying information, which may be used by the processing server 102 to identify the related payment transaction. For example, the processing server 102 may include a transaction identification value in the credit check request, which may be included in the response provided by the computing device 112. In another example, the computing device 112 may include the account identifier, which may be used by the processing server 102 to identify the account profile 208 for which there is an outstanding credit check request.

In step 326, the transmitting device 216 of the processing server 102 may electronically transmit a data signal to the credit bureau system 118 that is superimposed with a credit request. The credit request may be a request for credit information for the consumer 106. The credit request may include the credit data included in the authorization request submitted to the processing server 102 via the merchant system 114, such as the identifying information associated with the consumer 106 and a credit check type. In step 328, the receiving device 202 of the processing server 102 may receive a data signal electronically transmitted by the credit bureau system 118 via a suitable communication network and method that is superimposed or otherwise encoded with credit results.

In step 330, the transmitting device 216 of the processing server 102 may forward the credit results to the merchant system 114. In some embodiments, the credit results may be superimposed or otherwise encoded in a data signal electronically transmitted to the merchant system 114 via a suitable communication network and method, including the payment rails associated with the payment network 104, that may be separate from the authorization response for the payment transaction. In other embodiments, the credit results may be included in a data element included in the authorization response, such as the data element configured to store the credit identifier or a separate data element, which may be electronically transmitted to the merchant system 114 using the payment rails once the issuer system 108 has provided approval or denial of the payment transaction. In step 332, the merchant system 114 may receive the credit results and may act accordingly based on the results, such as by providing financing to the consumer 106 based on their credit.

It will be apparent to persons having skill in the relevant art that steps 326 and 328 may be not be performed in instances where the merchant system 114 may be performing the credit check. In such instances, the credit results provided to the merchant system 114 in steps 330 and 332 may be replaced by the consumer's authorization or denial of authorization, such that the merchant system 114 may act accordingly and receive the credit results from the credit bureau system 118 if authorized by the consumer 106.

### Processing of Real-Time Credit Check Authorizations

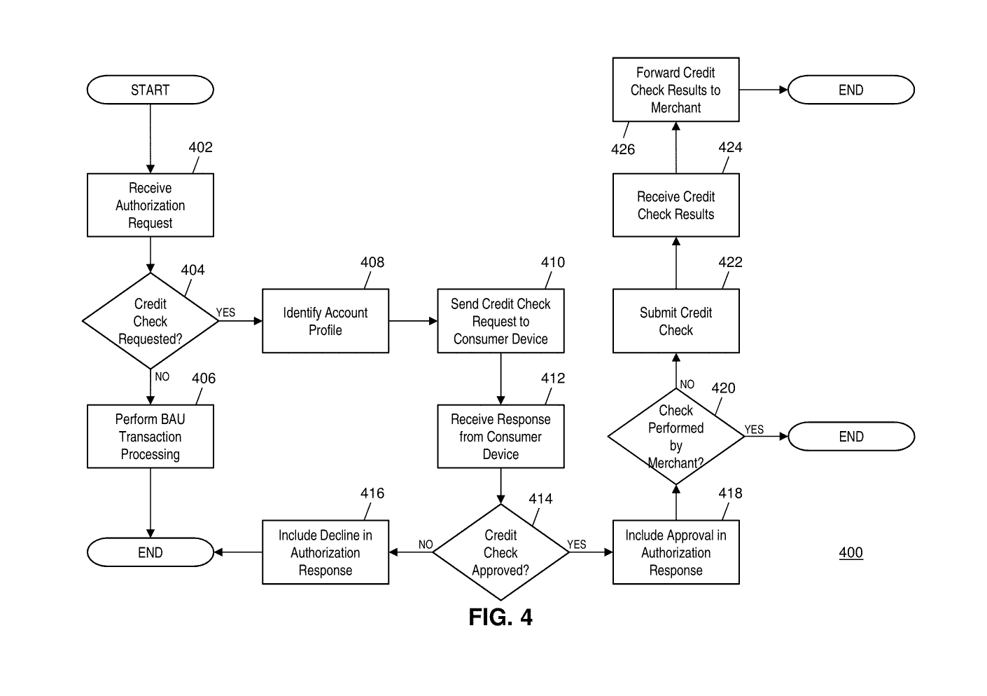

FIG. 4 illustrates a process 400 for the processing of real-time credit check authorizations by the processing server 102 as part of the processing of payment transactions.

In step 402, the receiving device 202 of the processing server 102 may receive an authorization request for a payment transaction. The authorization request may be a transaction message formatted pursuant to one or more standards, such as the ISO 8583 standard, that includes a message type indicator indicative of an authorization request and a plurality of data elements including at least a first data element configured to store a primary account number, a second data element configured to store credit data, and one or more additional data elements configured to store additional transaction data. The credit data may include an indication that a credit check is requested, and may also include identifying information associated with the consumer 106 for whom the credit check is requested, credit bureau identifying information, a credit check type, etc.

In step 404, the transaction processing module 214 of the processing server 102 may determine if a credit check is requested with the payment transaction. The determination may be based on the credit data stored in the second data element included in the authorization request. If the second data element does not include an indication that a credit check is requested, then, in step 406, the processing server 102 may process the payment transaction using business-as-usual (BAU) processing, such as described in more detail below with respect to the process 600 illustrated in FIG. 6.

If, in step 404, the transaction processing module 214 determines that a credit check is requested, then, in step 408, the querying module 210 of the processing server 102 may execute a query on the account database 206 of the processing server 102 to identify an account profile 208 where the included account identifier corresponds to the primary account number stored in the first data element included in the authorization request. In step 410, the transaction processing module 214 of the processing server 102 may generate a credit check request that includes data parsed from the data elements included in the authorization request and that is formatted based on the communication preferences stored in the identified account profile 208, and the transmitting device 216 of the processing server 102 may electronically transmit a data signal superimposed or otherwise encoded with the credit check request to the computing device 112 as indicated in the communication preferences stored in the identified account profile 208.

In step 412, the receiving device 202 of the processing server 102 may receive a data signal from the computing device 112 that is superimposed or otherwise encoded with a response from the consumer 106 associated with the identified account profile 208 that indicates authorization or a denial of authorization for the credit check. In step 414, the transaction processing module 214 may determine if the consumer 106 has approved or denied the requested credit check. The determination may be based on data parsed from the data signal returned by the computing device 112 from the consumer 106. If the credit check is not approved (e.g., the consumer 106 declined authorization for the credit check), then, in step 416, the data modification module 212 of the processing server 102 may include the denial of authorization in the authorization response for the transaction message that is to be transmitted to the merchant system 114 for the payment transaction. The denial may be stored in the second data element configured to store the credit data, or may be stored in a different data element included in the authorization response.

If, in step 414, the transaction processing module 214 determines that the credit check is approved by the consumer 106, then, in step 418, the data modification module 212 of the processing server 102 may include the consumer's approval in the authorization response to be transmitted to the merchant system 114 for the payment transaction. The approval may be stored in the second data element configured to store the credit data, or may be stored in a different data element included in the authorization response. In step 420, the processing server 102 may determine if the credit check is to be performed by the merchant system 114 or the processing server 102. The determination may be based on the credit data stored in the second data element included in the authorization request, an agreement with the merchant system 114 regarding credit checks, preferences of the consumer 106, such as may be stored in the identified account profile 208, etc. If the merchant system 114 is to perform the credit check, then the process 400 may be completed, where the payment network 104 may forward the authorization response to the merchant system 114 once transaction processing is completed, and the merchant system 114 may perform the credit check, if authorized.

If, in step 420, the processing server 102 determines that it should perform the credit check, then, in step 422, the transmitting device 216 of the processing server 102 may electronically transmit a data signal to the credit bureau system 118 that is superimposed or otherwise encoded with a credit check. The credit check may include some or all of the data stored in the data element configured to store the credit data included in the authorization request, such as identifying information associated with the consumer 106, credit check type, etc. In step 424, the receiving device 202 of the processing server 102 may receive a data signal superimposed or otherwise encoded with the results from the credit check from the credit bureau system 118. In step 426, the credit check results may be forwarded to the merchant system 114 by the transmitting device 216 of the processing server 102. In some embodiments, the credit check results may be superimposed or otherwise encoded on a data signal electronically transmitted to the merchant system 114 separate from the authorization response. In other embodiments, the credit check results may be stored in the authorization response, such as in the second data element or another suitable data element included therein. The process 400 may then be completed, where the payment network 104 may forward the authorization response to the merchant system 114 once transaction processing is completed.

### Exemplary Method for Determining Real-Time Authorization of a Credit Check

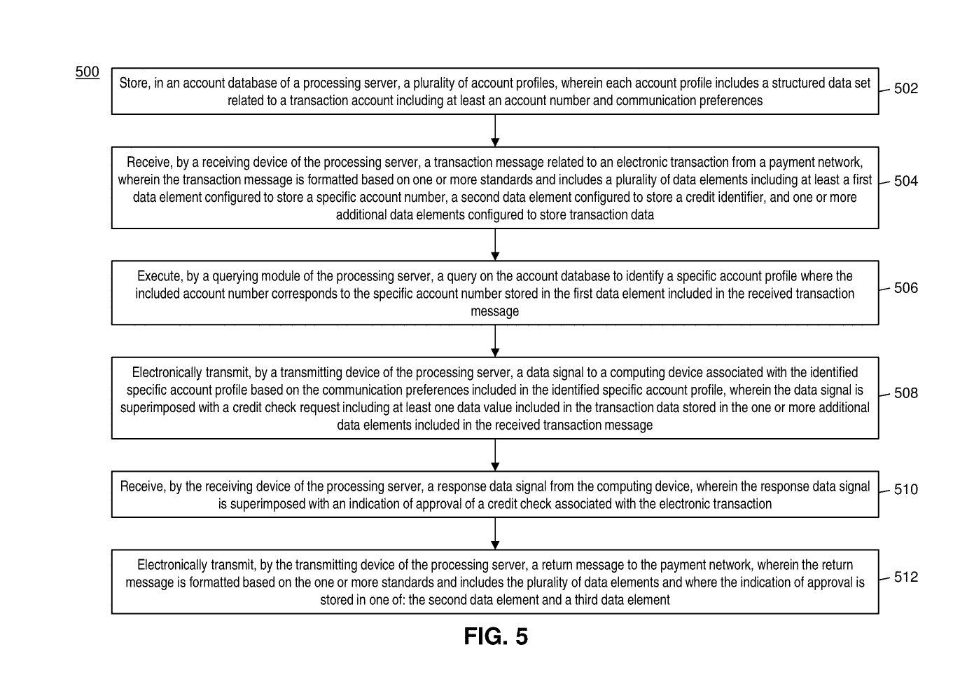

FIG. 5 illustrates a method 500 for real-time authorization of a credit check by a consumer involved in a payment transaction.

In step 502, a plurality of account profiles (e.g., account profiles 208) may be stored in an account database (e.g., the account database 206) of a processing server (e.g., the processing server 102), wherein each account profile includes a structured data set related to a transaction account including at least an account number and communication preferences. In step 504, a transaction message related to a payment transaction may be received by a receiving device (e.g., the receiving device 202) of the processing server from a payment network (e.g., the payment network 104), wherein the transaction message is formatted based on one or more standards and includes a plurality of data elements including at least a first data element configured to store a specific account number, a second data element configured to store a credit identifier, and one or more additional data elements configured to store transaction data.

In step 506, a query may be executed on the account database by a querying module (e.g., the querying module 210) of the processing server to identify a specific account profile where the included account number corresponds to the specific account number stored in the first data element included in the received transaction message. In step 508, a data signal may be electronically transmitted by a transmitting device (e.g., the transmitting device 216) of the processing server to a computing device (e.g., the computing device 112) associated with the identified specific account profile based on the communication preferences included in the identified specific account profile, wherein the data signal is superimposed with a credit check request including at least one data value included in the transaction data stored in the one or more additional data elements included in the received transaction message.

In step 510, a response data signal may be received from the computing device by the receiving device of the processing server, wherein the response data signal is superimposed with an indication of approval of a credit check associated with the electronic transaction. In step 512, a return message may be electronically transmitted by the transmitting device of the processing server to the payment network, wherein the return message is formatted based on the one or more standards and includes the plurality of data elements and where the indication of approval is stored in one of: the second data element and a third data element.

In some embodiments, the transaction message may further include a credit check type stored in one of: the second data element and a fourth data element, and the credit check request further includes the credit check type. In one embodiment, the method 500 may also include removing, from the return message, the credit identifier from the second data element prior to transmission. In some embodiments, the credit identifier may be a social security number.

In one embodiment, the method 500 may further include electronically transmitting, by the transmitting device of the processing server, a data signal to a credit bureau (e.g., the credit bureau system 118), wherein the data signal is superimposed with a credit request, the credit request including at least the credit identifier stored in the second data element included in the received transaction message. In a further embodiment, the credit request may further include data included in the transaction data stored in the one or more additional data elements included in the received transaction message associated with an entity for reporting of credit. In another further embodiment, the method 500 may even further include: receiving, by the receiving device of the processing server, a data signal from the credit bureau, wherein the data signal is superimposed with a credit report; and electronically transmitting, by the transmitting device of the processing server, a data signal to an entity associated with the electronic transaction, wherein the data signal is superimposed with the credit report and the entity is identified based on data stored in the one or more additional data elements included in the received transaction message.

In some embodiments, the method 500 may also include forwarding, by the transmitting device of the processing server, the received transaction message to a financial institution associated with the identified specific account profile. In a further embodiment, the method 500 may further include removing, from the received transaction message, the credit identifier from the second data element prior to forwarding. In another further embodiment, the method 500 may also include receiving, by the receiving device of the processing server, a response message from the financial institution, wherein the response message is formatted based on the one or more standards and includes the plurality of data elements including a fifth data element configured to store a response code indicative of approval of the electronic transaction, wherein the response message is received prior to transmission of the return message.

### Payment Transaction Processing System and Process

FIG. 6 illustrates a transaction processing system and a process 600 for the processing of potentially millions of payment transactions in a given time (e.g., week, day, hour, etc.) in the system. The process 600 and steps included therein may be performed by one or more components of the system 100 discussed above, such as the processing server 102, payment network 104, consumer 106, issuer system 108, payment instrument 110, merchant system 114, acquirer system 116, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3A, 3B, 4, and 5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8683 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8683 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 650, assuming the transaction was approved, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 602. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, and 4-6.

If programmable logic is used, such logic may execute on a commercially available processing platform configured by executable software code to become a specific purpose computer or a special purpose device (e.g., programmable logic array, application specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3A, 3B, and 4-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for determining real-time authorization of a credit check. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for determining real-time authorization of a credit check, comprising:
storing, in an account database of a processing server, a plurality of account profiles, wherein each account profile includes a structured data set related to a transaction account including at least an account number and communication preferences;
receiving, by a receiving device of the processing server, a transaction message related to an electronic transaction from a payment network, wherein the transaction message is formatted based on one or more standards and includes a plurality of data elements including at least a first data element configured to store a specific account number, a second data element configured to store a credit identifier, and one or more additional data elements configured to store transaction data;
executing, by a querying module of the processing server, a query on the account database to identify a specific account profile where the included account number corresponds to the specific account number stored in the first data element included in the received transaction message;
electronically transmitting, by a transmitting device of the processing server, a data signal to a computing device associated with the identified specific account profile based on the communication preferences included in the identified specific account profile, wherein the data signal is superimposed with a credit check request including at least one data value included in the transaction data stored in the one or more additional data elements included in the received transaction message;
receiving, by the receiving device of the processing server, a response data signal from the computing device, wherein the response data signal is superimposed with an indication of approval of a credit check associated with the electronic transaction; and
electronically transmitting, by the transmitting device of the processing server, a return message to the payment network, wherein the return message is formatted based on the one or more standards and includes the plurality of data elements and where the indication of approval is stored in one of: the second data element and a third data element.

2. The method of claim 1, wherein
the transaction message further includes a credit check type stored in one of: the second data element and a fourth data element, and
the credit check request further includes the credit check type.

3. The method of claim 1, further comprising:
removing, from the return message, the credit identifier from the second data element prior to transmission.

4. The method of claim 1, further comprising:
electronically transmitting, by the transmitting device of the processing server, a data signal to a credit bureau, wherein the data signal is superimposed with a credit request, the credit request including at least the credit identifier stored in the second data element included in the received transaction message.

5. The method of claim 4, wherein the credit request further includes data included in the transaction data stored in the one or more additional data elements included in the received transaction message associated with an entity for reporting of credit.

6. The method of claim 4, further comprising:
receiving, by the receiving device of the processing server, a data signal from the credit bureau, wherein the data signal is superimposed with a credit report; and
electronically transmitting, by the transmitting device of the processing server, a data signal to an entity associated with the electronic transaction, wherein the data signal is superimposed with the credit report and the entity is identified based on data stored in the one or more additional data elements included in the received transaction message.

7. The method of claim 1, further comprising:
forwarding, by the transmitting device of the processing server, the received transaction message to a financial institution associated with the identified specific account profile.

8. The method of claim 7, further comprising:
removing, from the received transaction message, the credit identifier from the second data element prior to forwarding.

9. The method of claim 7, further comprising:
receiving, by the receiving device of the processing server, a response message from the financial institution, wherein the response message is formatted based on the one or more standards and includes the plurality of data elements including a fifth data element configured to store a response code indicative of approval of the electronic transaction, wherein
the response message is received prior to transmission of the return message.

10. The method of claim 1, wherein the credit identifier is a social security number.

11. A system for determining real-time authorization of a credit check, comprising:
an account database of a processing server configured to store a plurality of account profiles, wherein each account profile includes a structured data set related to a transaction account including at least an account number and communication preferences;
a receiving device of the processing server configured to receive a transaction message related to an electronic transaction from a payment network, wherein the transaction message is formatted based on one or more standards and includes a plurality of data elements including at least a first data element configured to store a specific account number, a second data element configured to store a credit identifier, and one or more additional data elements configured to store transaction data;
a querying module of the processing server configured to execute a query on the account database to identify a specific account profile where the included account number corresponds to the specific account number stored in the first data element included in the received transaction message; and
a transmitting device of the processing server configured to electronically transmit a data signal to a computing device associated with the identified specific account profile based on the communication preferences included in the identified specific account profile, wherein the data signal is superimposed with a credit check request including at least one data value included in the transaction data stored in the one or more additional data elements included in the received transaction message, wherein
the receiving device of the processing server is further configured to receive a response data signal from the computing device, wherein the response data signal is superimposed with an indication of approval of a credit check associated with the electronic transaction, and
the transmitting device of the processing server is further configured to electronically transmit a return message to the payment network, wherein the return message is formatted based on the one or more standards and includes the plurality of data elements and where the indication of approval is stored in one of: the second data element and a third data element.

12. The system of claim 11, wherein
the transaction message further includes a credit check type stored in one of: the second data element and a fourth data element, and
the credit check request further includes the credit check type.

13. The system of claim 11, further comprising:
a data modification module configured to remove, from the return message, the credit identifier from the second data element prior to transmission.

14. The system of claim 11, wherein the transmitting device of the processing server is further configured to electronically transmit a data signal to a credit bureau, wherein the data signal is superimposed with a credit request, the credit request including at least the credit identifier stored in the second data element included in the received transaction message.

15. The system of claim 14, wherein the credit request further includes data included in the transaction data stored in the one or more additional data elements included in the received transaction message associated with an entity for reporting of credit.

16. The system of claim 14, wherein
the receiving device of the processing server is further configured to receive a data signal from the credit bureau, wherein the data signal is superimposed with a credit report, and
the transmitting device of the processing server is further configured to electronically transmit a data signal to an entity associated with the electronic transaction, wherein the data signal is superimposed with the credit report and the entity is identified based on data stored in the one or more additional data elements included in the received transaction message.

17. The system of claim 11, wherein the transmitting device of the processing server is further configured to forward the received transaction message to a financial institution associated with the identified specific account profile.

18. The system of claim 17, further comprising:
a data modification module configured to remove, from the received transaction message, the credit identifier from the second data element prior to forwarding.

19. The system of claim 17, wherein
the receiving device of the processing server is further configured to receive a response message from the financial institution, wherein the response message is formatted based on the one or more standards and includes the plurality of data elements including a fifth data element configured to store a response code indicative of approval of the electronic transaction, and
the response message is received prior to transmission of the return message.

20. The system of claim 11, wherein the credit identifier is a social security number.
